(19) United States
(12) Patent Application Publication
(10) Pub. No.: US 2007/0171789 A1
(43) Pub. Date: Jul. 26, 2007

(54) Data storage medium and storage device

(75) Inventors: Akiyoshi Uchida, Kawasaki (JP); Toshikazu Kanaoka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/411,329

(22) Filed: Apr. 26, 2006

(30) Foreign Application Priority Data
Jan. 26, 2006 (JP) 2006-017880

(51) Int. Cl. G11B 20/10

(52) U.S. Cl. 369/47.22; 369/275.3

(57) ABSTRACT

A data storage medium includes a data area used for storing data, an address area used for identifying the data area, a first mark that is formed in the address area and represents a bit string corresponding to an address, and a second mark that is formed in a vicinity of the address area and indicates a position where each of all bits in the bit string corresponding to the address is arranged.

### BACKGROUND OF THE INVENTION

1. Field of the Invention

The present invention relates to data storage media on which marks representing bit strings corresponding to addresses are formed and storage devices for using the data storage media.

2. Description of the Related Art

Data storage disks such as magnetic disks, magneto-optical disks and optical disks are used for various purposes. Generally, access to these data storage media, i.e., reading or writing data is performed while a data storage medium spins at a constant speed.

As a method for specifying access positions, there is proposed a method, of previously forming marks (hereinafter referred to as address marks) each of which corresponds to a bit string and represents a section address of each of many sections into which a recoding surface is divided. The address marks are structural characteristics and are detectable optically or magnetically. For example, in DVD-RAMs as wobble land groove format optical disks, a track that a head traces is divided into user data areas and address areas in which pits are formed as address marks.

Address information represented by the address marks are converted into binary data in address control. On this occasion, a clock is used which is synchronized with spins of a data storage medium and has a cycle corresponding to bit array pitches in the address marks. More specifically, binary data are produced by signal processing in which read signals obtained at the time of tracing the address marks at a constant speed are sampled in accordance with the clock and the sampled values are binarized.

In order to generate clocks, a method of previously forming marks for generating clocks (hereinafter referred to as clock marks) on data storage media is widely used. Japanese unexamined patent publication No. 2001-35089, for example, discloses a servo format in which pits are discretely formed at predetermined intervals on tracks as clock marks. According to this format, a PLL (Phase Locked Loop) circuit generates desired clocks based on pulse signals at the time when clock marks are read from a spinning data storage medium. Further, there is proposed a servo format of forming wobbles as clock marks, i.e., a format of obtaining clocks using regularly meandering grooves. Japanese unexamined patent publication No. 11-175979, for example, relates to an optical disk including tracks where address areas (lands) and user data areas (grooves) are arranged alternately. The publication describes that, in such an optical disk, grooves of the user data areas are formed to have a serpentine shape and pits formed as address marks on the address areas are formed to have a serpentine shape, similarly to the meandering of the grooves. In optical disks of this type, continuous clocks can be obtained as if there were wobbles over the entire length of tracks.

Further, storage devices for recording data using holograms are known. Storage devices have recently been developed in which a plurality of interference patterns is recorded in one area in multiplex mode with the aim of improving storage density.

Multiple recording is a volume type in which three-dimensional interference patterns are formed inside recording layers of data storage media. The multiple recording requires irradiation of exposure energy enough to alter the inside of the recording layer. Japanese patent No. 3639212 discloses related art of such multiple recording.

The optical information recording method according to Japanese patent No. 3639212 is one of recording methods called “Stop and Go”. In the optical information recording method, when data are written, an irradiating spot of reference light and information light is temporarily moved along the spin direction of a data storage medium at the same speed as spins thereof. Then, when the writing process to one area is completed, the irradiating spot is moved at speeds lower than the data storage medium such that the irradiating spot reaches an area to which data are to be written subsequently. Since, in writing processes, an area to be written and the irradiating spot is moved along the same direction at the same speed, the irradiating spot is stationary with respect to the area to be written. This eliminates the need for a high-power pulse laser light source, which makes it possible to realize sufficient exposure using a practical semiconductor laser.

Further, Japanese patent No. 3639212 discloses two techniques for reading address marks to recognize the addresses correctly during a period when a speed of relative movement between the irradiating spot and the data storage medium is not constant but increased or reduced: 1. When pits are formed as the address marks beforehand, an inference is made of an aspect of change in relative movement speed (rate of change, time or the like) when a head traces address areas where pits are arranged, and the pit length and the pit array pitches are made smaller with reducing the relative movement speed. In this way, it is possible to obtain binary data (address) by sampling read signals at a constant period as in the case where the relative movement speed is constant. 2. Signal processing is performed on read signals based on movement speed information possessed by a controller for controlling the relative movement. This makes it possible to obtain desired binary data.

Conventional data storage media have the problem that, when they are used for the stop and go recording, information on address marks cannot be read reliably and promptly from the address marks.

First, with conventional data storage media on which address marks are formed on the premise of access during spinning at a constant speed, which are commonly used, when a speed of relative movement between such a data storage medium and a head tracing the address marks changes, information of the address marks cannot be read correctly therefrom. Accordingly, it is necessary to make a speed tracing address marks constant in stop and go operations in which an irradiating spot is temporarily moved along the spin direction at the same speed as spins of a data storage medium as in the conventional case. Note that, according to general stop and go recording, a storage medium stops at the time of recording and as soon as the recording is finished, a head moves to the next record spot. Such an operation entails acceleration when a head starts moving from a certain spot to a destination spot and deceleration when the head stops at the destination spot. Thus, the speed is not made constant, which requires fine adjustment of movement in the vicinity of the spots. For this reason, quick addressing cannot be expected.

Further, even if the technique disclosed by Japanese patent No. 3639212, i.e., the technique of performing signal processing based on movement speed information possessed by a controller, is applied to the stop and go operations using commonly used conventional data storage media, reading addresses correctly is difficult. Because it is not necessarily the case that an actual movement speed of an address mark to be noted is completely equal to a speed indicated in the movement speed information.

Next, with conventional data storage media having address marks whose length and array pitch are set on the premise of reading during a period when a relative movement speed changes as described above, addresses cannot be read reliably when differences arise between change in actual relative movement speed and assumed change. In particular, since differences are likely to arise between actual change and assumed change in random access, the probability of addressing failure is high.

### SUMMARY OF THE INVENTION

The present invention is directed to solve the problems pointed out above, and therefore, an object of the present invention is to realize quick and reliable addressing operations under the state where a speed of relative movement between a head for access and a data storage medium changes. Another object of the present invention is to provide data storage media suitable for the stop and go recording.

According to one aspect of the present invention, a data storage medium includes a data area used for storing data, an address area used for identifying the data area, a first mark that is formed in the address area and represents a bit string corresponding to an address, and a second mark that is formed in a vicinity of the address area and indicates a position where each of all bits in the bit string corresponding to the address is arranged.

The first mark and the second mark are structural characteristics and can be detected optically or magnetically. Typical marks include pits, phase change films and wobbles.

The data storage medium is incorporated into a storage device. The storage device includes a head for access, a drive mechanism for moving the data storage medium and the head relative to each other, and a controller for controlling the drive mechanism.

The head reads the first mark and the second mark concurrently to output a first read signal corresponding to the first mark and a second read signal corresponding to the second mark.

The controller samples the first read signal in synchronism with the second read signal, thereby to detect a bit string corresponding to the address.

The head reads the first mark and the second mark simultaneously to output a first read signal corresponding to the first mark and a second read signal corresponding to the second mark.

The controller samples the first read signal in synchronism with the second read signal, thereby to detect a bit string corresponding to an address.

The second marks move along with the first marks with respect to the head. So, a value transition of the second read signal always corresponds to a value transition of the first read signal irrespective of the movement speed. Accordingly, the first read signal is sampled correctly in a period when the signal value of the first read signal changes depending on change in movement speed. The second marks are bit-corresponding marks indicating respective arrangement positions of all the bits in a bit string corresponding to an address. Accordingly, the sampling of the first read signal enables accurate detection of all the bits in the address.

The present invention makes it possible to realize quick and reliable addressing operations under the state where a speed of relative movement between a head for access and a data storage medium changes.

These and other characteristics and objects of the present invention will become more apparent by the following descriptions of preferred embodiments with reference to drawings.

### BRIEF DESCRIPTION OF THE DRAWINGS

FIG. 1 is a diagram showing a schematic configuration of a data storage device according to the present invention.

FIG. 2 shows an example of a physical format in a data storage medium according to the present invention.

FIG. 3 is an explanatory diagram of clock marks according to the present invention.

FIG. 4 is an explanatory diagram of clock address marks according to the present invention.

FIG. 5 is a flowchart showing an outline of an access operation according to the present invention.

FIG. 6 shows an arrangement relationship of clock address marks in adjacent tracks.

FIGS. 7A and 7B show modifications of the clock marks.

### DESCRIPTION OF THE PREFERRED EMBODIMENTS

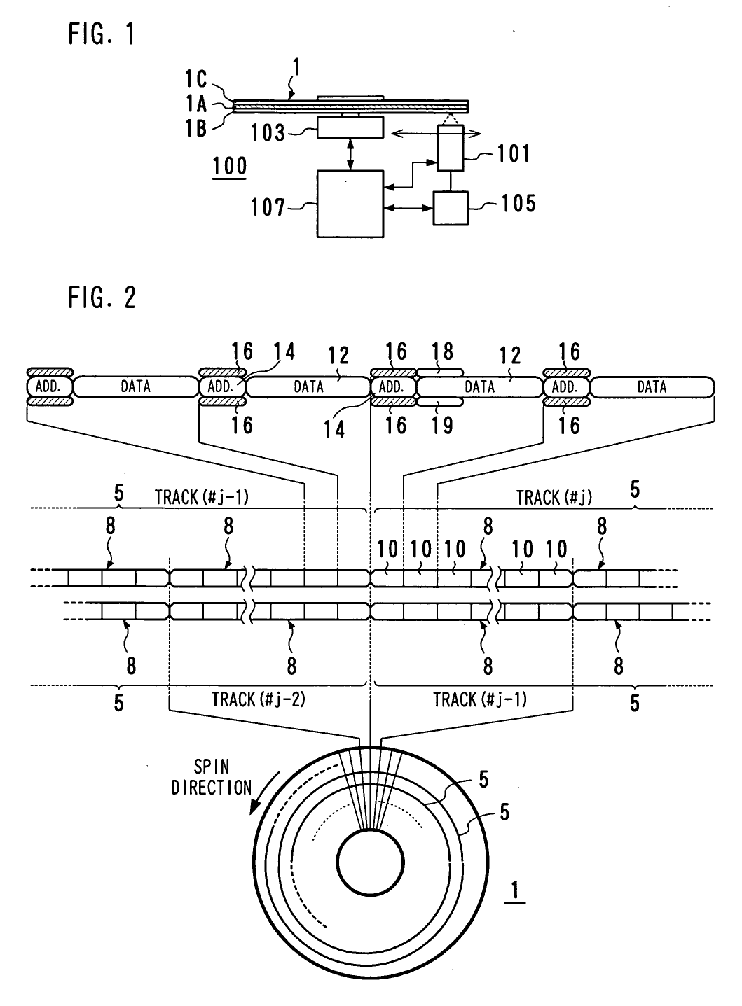

FIG. 1 is a diagram showing a schematic configuration of a data storage device according to the present invention. The illustrated data storage device 100 performs multiple recording of interference patterns. The multiple recording mode is angular multiplexing in which one area is irradiated with reference beams and information beams plural times with incident angles being changed little by little. Since known publications including Japanese patent No. 3639212 mentioned above disclose detailed configurations of devices of this type, detailed description thereof is omitted herein.

The data storage device 100 includes a data storage medium 1, an optical head 101, a spindle motor 103, a head drive mechanism 105 and a controller 107.

The data storage medium 1 is a disk including a recording layer 1A on which data are recorded using holograms and a pair of substrates 1B and 1C sandwiching the recording layer 1A therebetween. A material for the recording layer 1A is cationic polymerization photopolymer or radical polymerization photopolymer. The substrates 1B and 1C are made from glass or resin such as polycarbonate. A protection film, an anti-reflection film or others (not shown) is laminated on each of the substrates 1B and 1C.

The optical head 101 serves to perform optical operations for accessing the recording layer 1A, i.e., to project and receive laser beams for writing and reading hologram information. The optical head 101 also serves to project and receive laser beams for reading address marks and clock marks described later. Receiving beams includes photoelectric conversion. One or both of a light source and a light receiving element may or may not be used in common in order to access the recording layer 1A and to read marks.

The spindle motor 103 turns the data storage medium 1. The spindle motor 103 is drive means for moving the data storage medium 1 and the optical head 101 relative to each other.

The head drive mechanism 105 moves the optical head 101 along the radial direction of the data storage medium 1 in seek operations.

The controller 107 controls the spindle motor 103 and the head drive mechanism 105. In access by the stop and go recording, the controller 107 stops spins of the data storage medium 1 temporarily to make the optical head 101 and the data storage medium 1 stationary relative to each other. The controller 107 samples light receiving signals output from the optical head 101 in synchronism with a clock, which is described later, thereby to detect addresses recorded on the data storage medium 1. An addressing operation is performed based on the addresses thus detected.

It is possible to adopt a head structure in which the optical head 101 is temporarily moved along the spin direction of the data storage medium 1 as in the disclosure of Japanese patent No. 3639212, thereby to realize stop and go operations.

FIG. 2 shows an example of a physical format in a data storage medium according to the present invention.

Referring to FIG. 2, the data storage medium 1 includes a plurality of tracks 5 arranged in a spiral. The tracks 5 may be arranged in concentric circles. Each of the tracks 5 draws a line of one turn around the center of the data storage medium 1.

The data storage medium 1 is radially divided into many fan-shaped areas having the same central angle. Each of the tracks 5 has a plurality of frames 8 each of which corresponds to one fan-shaped area. Each of the frames 8 is divided along the circumferential direction and made up of a plurality of sectors 10. Each of the sectors 10 has a data area 12 used for memorizing data and an address area 14 for identifying the data area 12.

The data storage medium 1 has clock mark areas 16 on the both sides of each of the address areas 14 along the track pitch direction. The leading sector 10, along the spin direction of the data storage medium 1, in each of the frames 8 has a first frame address area 18 adjacent to one of the two clock mark areas 16 and a second frame address area 19 adjacent to the other clock mark area 16.

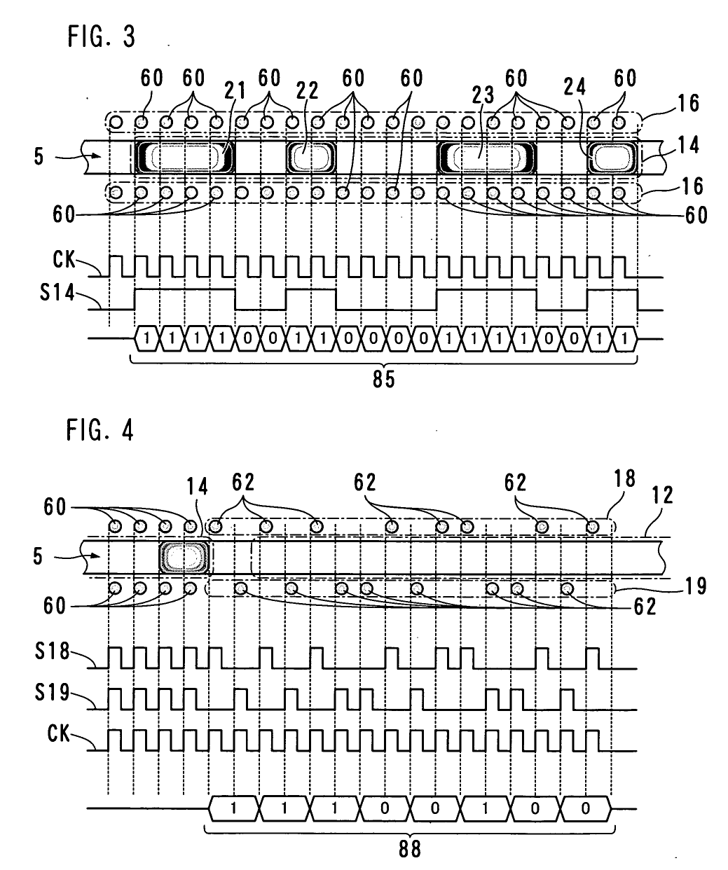

FIG. 3 is an explanatory diagram of clock marks according to the present invention.

Address marks 21, 22, 23 and 24 representing bit strings according to track addresses and sector addresses are formed in the address area 14 of the track 5. The address marks 21, 22, 23 and 24 are first marks of the present invention. The mark recording method may be mark position recording or mark edge recording.

A plurality of clock marks 60, which are second marks according to the present invention, is formed in each of a pair of the clock mark areas 16 sandwiching the address area 14 therebetween. The two clock mark areas 16 have the same structure. The clock marks 60 in each of the clock mark areas 16 indicate positions where all bits in an address bit string recorded in the address area 14 are arranged. In this example, the array format of the clock marks 60 is the mark position format and each of the clock marks 60 indicates an arrangement position of one bit.

The optical head 101 traces either one or both of the two clock mark areas 16 in parallel with the trace of the address area 14. Thereby, a clock CK that is made up of pulses corresponding to the respective clock marks 60 is obtained in the form of a synchronization signal.

A pulse period of the clock CK depends on a tracing speed. If the tracing speed is constant, the pulse period of the clock CK is also constant as shown in the drawing. In contrast, if the tracing speed changes, a pulse width and a pulse interval of each pulse of the clock CK change accordingly. In stop and go operations, during deceleration, the pulse width and the pulse interval gradually increase as time passes. During stationary, the pulse width and the pulse interval are infinite. During acceleration, the pulse width and the pulse interval gradually decrease.

As described earlier, the clock marks 60 are formed in a manner to correspond to bits in an address bit string. So, while the pulse period changes, the timing when each pulse of the clock CK appears coincides with the timing when an arrangement position of each bit in the address area 14 is traced. Accordingly, a read signal S14 that is obtained by tracing the address area 14 are sampled in synchronism with the clock CK and the sampled values are binarized, so that addresses 85 previously recorded in the address area 14 can be precisely detected in the form of binary data.

FIG. 4 is an explanatory diagram of clock address marks according to the present invention.

Clock address marks 62, which are third marks according to the present invention, are formed in the first frame address area 18 and the second frame address area 19. The clock address marks 62 are arranged one by one in each of small areas (portions between adjacent broken lines of the track 5 in the drawing) that are provided by dividing the track 5 at regular intervals along the length direction. The intervals are the same as the array pitches of the clock marks 60. When one clock address mark 62 corresponding to one of the small areas is placed in the first frame address area 18, no clock address mark 62 corresponding to the small area is present in the second frame address area 19. Likewise, when one clock address mark 62 corresponding to one of the small areas is placed in the second frame address area 19, no clock address mark 62 corresponding to the small area is present in the first frame address area 18. Stated differently, supposing that one small area is regarded as an arrangement area for one bit, a value of each bit in a bit string represented by the clock address marks 62 formed on the first frame address area 18 is opposite to a value of each bit in a bit string represented by the clock address marks 62 formed in the second frame address area 19.

The first frame address area 18 and the second frame address area 19 are traced concurrently with each other. A read signal S18 obtained by tracing the first frame address area 18 is combined with a read signal S19 obtained by tracing the second frame address area 19 to have a logical sum thereof, so that a clock CK can be obtained. Then, in synchronism with the clock CK, a combination of a value of the read signal S18 and a value of the read signal S19 is determined in two pulse periods of the clock CK, so that a frame address 88 can be detected. Referring to the example of FIG. 4, when the read signal S18 has a value of 1 (pulse present) at a first pulse in the two pulse periods, a bit value of the frame address 88 is 1. When the read signal S19 has a value of 1 at a first pulse, a bit value of the frame address 88 is 0.

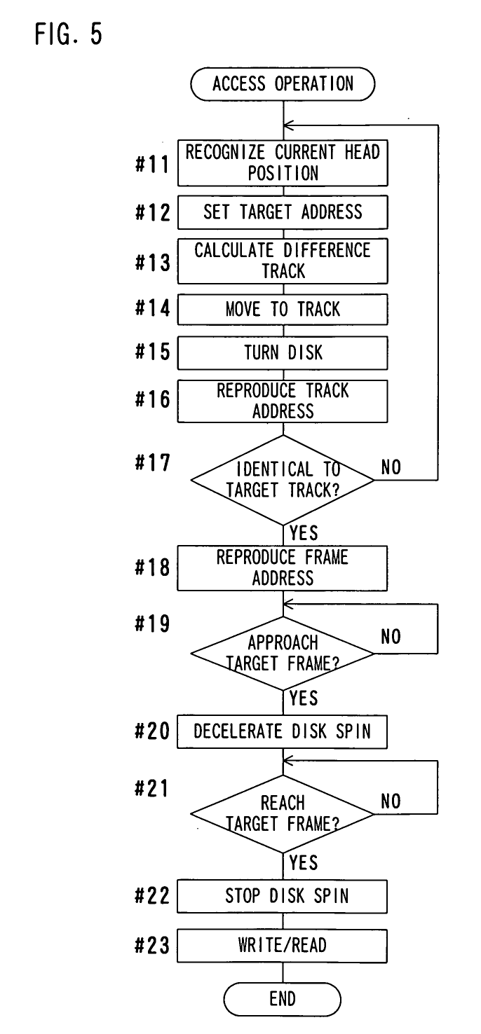

FIG. 5 is a flowchart showing an outline of an access operation according to the present invention.

The controller 107 recognizes a position where the optical head 101 faces the data storage medium 1 (hereinafter referred to as a head position for convenience) based on the latest address that was detected before (#1). A target address is set in accordance with an access request made from an external device (#12) to calculate a difference track that is a seek amount (#13). The controller 107 moves the optical head 101 to a track corresponding to the target address (#14). The seek operations include acceleration and deceleration. In parallel with the seek operations, the controller 107 starts to turn the data storage medium 1 (disk spin) (#15). Then, the controller 107 samples the read signal S14 in synchronism with the clock CK and binarizes the sampled values, thereby to detect an address 85. Stated differently, the controller 107 recognizes the track that the optical head 101 traces currently.

The operations described above are repeated until the current head position is identical to a target track (#17).

When the optical head 101 reaches the target track, the frame address 88 is detected (#18). When the head position approaches a target frame (#19), the controller 107 decelerates the disk spin (#20). When the head position reaches the target frame (#21), the controller 107 stops the disk spin (#22). Then, writing/reading data is performed (#23).

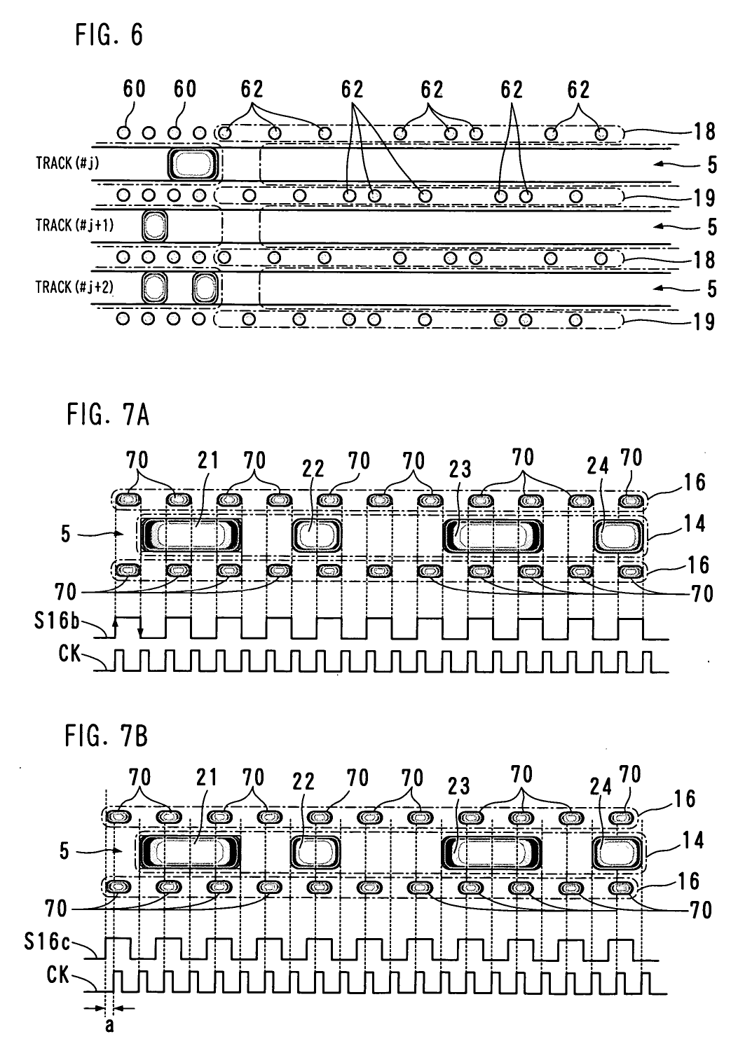

FIG. 6 shows an arrangement relationship of clock address marks in adjacent tracks.

With the data storage medium 1, the first frame address areas 18 and the second frame address areas 19 are arranged for each of the tracks 5 as described earlier. More particularly, in the data storage medium 1, only either one of the first frame address area 18 and the second frame address area 19 is provided in one interspace between the tracks 5 arranged along the radial direction as shown in FIG. 6. In other words, the first frame address area 18 and the second frame address area 19 are arranged alternately in interspaces between the tracks. This can enhance the array density of the tracks 5 compared to the case where the first frame address area 18 corresponding to one of the adjacent tracks 5 and the second frame address area 19 corresponding to the other track 5 are arranged in the interspace between the tracks 5.

Since the data storage medium 1 is radially divided into many areas, as described earlier with reference to FIG. 2, the positions of the frames 8 in the circumferential direction are the same among the tracks 5 adjacent to each other in the radial direction. Accordingly, frame address information possessed by the first frame address area 18 and the second frame address area 19 arranged in the radial direction may be identical to each other.

FIGS. 7A and 7B show modifications of the clock marks.

Referring to FIGS. 7A and 7B, a plurality of clock marks 70 is formed in the clock mark areas 16 by the mark edge recording method. More specifically, the leading edge and the trailing edge of each of the clock marks 70 in the circumference direction correspond to an array area for one bit each in the address area 14.

A clock CK similar to that in FIG. 3 can be obtained by detecting a leading edge and a trailing edge of each pulse of read signals S16b and S16c obtained by tracing the clock mark area 16.

Referring to FIG. 7A, edge positions of each of the clock marks 70 in the circumferential direction coincide with circumferential direction positions of an array area for one bit in the address area 14. Referring to FIG. 7B, edge positions of each of the clock marks 70 in the circumferential direction are different from circumferential direction positions of an array area for one bit in the address area 14. In the case of FIG. 7B, a read signal of the address area 14 may be sampled using a clock CK having a delay “a” corresponding to a position deviation from a leading edge and a trailing edge of each pulse of the read signal S16c.

The embodiments mentioned above describe, as one example, the reflective data storage medium 1 to which the optical head 101 provided on one side of the recording layer 1A accesses. However, the data storage medium may have a transmissive layer structure. In the data storage medium 1 according to the embodiments described above, it is sufficient that the clock marks 60, 70 and the clock address marks 62 are optically readable marks such as pits, wobbles and phase change films.

The physical format including the array and the division form of the tracks 5, the address values and the number of bits of the addresses 85 and the frame addresses and the multiple recoding method are not limited to the embodiments described above. For example, it is possible to provide the first and second frame address areas 18 and 19 in all of the sectors 10.

The present invention is not limited to optical disks and is also applicable to magnetic disks. In the case where desired recording density can be obtained by multiple recording, it is not necessarily that a recoding layer and a head are moved relative to each other at high speeds. Accordingly, it is not necessary to use disks as the data storage media. The present invention can apply to devices having a structure in which a data storage medium is fixedly arranged and only a head moves.

The present invention is useful for writing and reading data in the stop and go recording.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A data storage medium comprising:
a data area used for storing data;
an address area used for identifying the data area;
a first mark that is formed in the address area and represents a bit string corresponding to an address; and
a second mark that is formed in a vicinity of the address area and indicates a position where each of all bits in the bit string corresponding to the address is arranged.

2. A disk-shaped data storage medium comprising:
a plurality of tracks arranged in concentric circles or in a spiral;
a data area used for storing data and an address area used for identifying each of the tracks, the data area and the address area being included in the track;
a first mark that is formed in the address area and represents a bit string corresponding to a track address; and
a second mark that is formed in a vicinity of the address area and indicates a position where each of all bits in the bit string corresponding to the track address is arranged.

3. The data storage medium according to claim 2, further comprising third marks that are formed on both sides of each of the tracks and are arranged along the track,
wherein the third marks represent a bit string in which a circumferential direction position of an area where the third marks are formed is coded, and
a value of each bit in the bit string represented by the third mark formed on one side of each of the tracks is opposite to a value of each bit in the bit string represented by the third mark formed on the other side of each of the tracks.

4. The data storage medium according to claim 2, further comprising a recording layer, made of a photosensitive material, on which data can be recorded using a hologram, and
a substrate for supporting the recording layer thereon.

5. A data storage device comprising:
a data storage medium;
a head for accessing the data storage medium;
a drive portion for moving the data storage medium and the head relative to each other; and
a controller for controlling the drive portion,
wherein
the data storage medium includes a data area used for storing data and an address area used for identifying the data area,
a first mark representing a bit string corresponding to an address is formed in the address area of the data storage medium,
a second mark indicating a position where each of all bits in the bit string corresponding to the address is arranged is formed in a vicinity of the address area of the data storage medium,
the head reads the first mark and the second mark concurrently to output a first read signal corresponding to the first mark and a second read signal corresponding to the second mark, and
the controller samples the first read signal in synchronism with the second read signal, thereby to detect a bit string corresponding to the address.
